(19) United States
(12) Patent Application Publication
(10) Pub. No.: US 2016/0164084 A1
(43) Pub. Date: Jun. 9, 2016

(54) HIGH ENERGY DENSITY SILICIDE-AIR BATTERIES

(71) Applicant: THE REGENTS OF THE UNIVERSITY OF CALIFORNIA, Oakland, CA (US)

(72) Inventors: Xiangfeng DUAN, Los Angeles, CA (US); Yu HUANG, Los Angeles, CA (US); Hua ZHANG, Los Angeles, CA (US); Xing ZHONG, Los Angeles, CA (US)

(21) Appl. No.: 14/907,163

(22) PCT Filed: Jul. 24, 2014
(86) PCT No.: PCT/US14/48046

§ 371 Date: Jan. 22, 2016

Related U.S. Application Data
(60) Provisional application No. 61/858,423, filed on Jul. 25, 2013.

(51) Int. Cl. H01M 4/38; H01M 12/06

(52) U.S. Cl. CPC H01M 4/386; H01M 12/06; H01M 2004/027

(57) ABSTRACT

A silicide-air battery includes an anode, a cathode, and an electrolyte disposed between the anode and the cathode. The anode includes a metal silicide represented as MxSiy, where M is at least one metal selected from alkaline earth metals, transition metals, and post-transition metals.

### CROSS REFERENCE TO RELATED APPLICATION

This application claims the benefit of U.S. Provisional Application Ser. No. 61/858,423, filed on Jul. 25, 2013, the content of which is incorporated herein by reference in its entirety.

### TECHNICAL FIELD

This disclosure generally relates to metal silicide-based anode materials and batteries incorporating such anode materials.

### BACKGROUND

Amongst various battery technologies, metalair batteries have captured much attention recently due to their potential for very high energy densities. For example, commercialized zinc (Zn)air batteries can provide a practical energy density of about 350 W h kg⁻¹ out of a theoretical value of about 1370 W h kg⁻¹. The Znair system has several advantages over other metalair batteries such as the low cost of raw materials, flat discharge profile, and environmental benignity, but is currently constrained by relatively low energy density due to its large atomic weight. The aluminum (Al)air system can provide a theoretical anode energy density of about 8,100 W h kg⁻¹, but suffers from self-discharge. The lithium (Li)air system, with an exceptionally high theoretical energy density of about 13,000 W h kg⁻¹, has also attracted considerable attention for its potential to provide an anode material with a projected energy density of about 1,700 W h kg⁻¹. However, the Liair system can be constrained by the scarcity, chemical instability, and explosive hazard of the highly reactive elemental lithium. Also, Liair systems are currently constrained by low practical energy density.

Other materials, such as metal borides and phosphides, have also been investigated as potential candidates for high energy density anode materials, but these materials often suffer from rather low open circuit voltages, and the poor intrinsic conductivity of these materials can also constrain the achievable power density of these systems and often dictates the use of additional conductive additives such as carbon black.

It is against this background that a need arose to develop the metal silicide-based anode materials described herein.

### SUMMARY

High density electrochemical energy storage is of importance for mobile power and other applications. The relatively low energy density and high cost associated with the current approaches to electrochemical energy storage, including various battery and supercapacitor technologies, have been a significant challenge for mobile power supply. Embodiments of this disclosure are directed to a class of metal silicide-based anode materials for metalair primary batteries with unprecedented energy density. Several features of metal silicide materials including high electron capacity, high conductivity, high operating voltage, high earth abundance, and environmental benignity make them an attractive class of materials for energy storage. In some embodiments, this disclosure demonstrates that a series of metal silicide anodes (e.g., Mg₂Si, TiSi₂, CoSi₂, and VSi₂) can exhibit excellent electrochemical performance with unparalleled capacity. In some embodiments, this disclosure further specifies gravolumetric energy density (the product of gravimetric and volumetric energy densities) as a figure-of-merit to simultaneously characterize the energy density from both gravimetric and volumetric scales. With this figure-of-merit, this disclosure demonstrates that a silicide system offers substantial combined advantages over other energy storage technologies, with the projected gravolumetric energy density of a TiSi₂air system more than about 3-10 times better than that of zincair or aluminumair systems. With further optimization, metal silicides can be used as anode materials with unparalleled energy density and can open up exciting opportunities for mobile power applications.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1: Theoretical gravimetric (a) and volumetric (b) anode energy density plot for batteries.

FIG. 2: Characterization of a magnesium silicide thin film. (a) Top view scanning electron microscopy (SEM) image of the Mg₂Si thin film on a silicon wafer. (b) Cross-sectional SEM image of the Mg₂Si thin film on the silicon wafer. (c) X-ray diffraction (XRD) patterns of Mg₂Si on the silicon wafer. (d) Linear sweep voltammograms of the Mg₂Si thin film. (e) Electrochemical impedance spectra of the Mg₂Si thin film. (f) Galvanostatic discharge curve of the Mg₂Siair or Siair battery in about 30% KOH solution with various discharge currents. The scale bars in (a) and (b) are 10 μm.

FIG. 3: Electrochemical performance of silicideair batteries. (a) Polarization curves for silicide pellets in about 30% KOH solution. (b) Discharge curves for silicide pellets with different discharge currents (mA). (c) Discharge curves for TiSi₂, VSi₂, and CoSi₂ pellets at a discharge rate of about 1 mA. (d) Capacity measurements for TiSi₂, VSi₂, and CoSi₂ powders at a discharge current of about 1 mA.

FIG. 4: (a) Gravimetric and (b) volumetric anode capacity for various anode materials. (c) Gravolumetric energy density plot of the practical values (left) obtained in Znair battery, Alair battery, and Siair batteries and the projected values (right) in silicideair batteries.

FIG. 5: A schematic of a silicideair battery.

### DETAILED DESCRIPTION

Continued efforts in the development of improved material systems are desired to meet the ever increasing demands for mobile power supply, among other applications. In general, in order to identify an optimal anode material, several basic considerations should be taken into account. First, it should deliver sufficient theoretical energy density; second, it should be composed of earth abundant and potentially low cost elements; third, it should be environmentally friendly; fourth, it should be conductive; and fifth, it should have a high redox potential for high operation voltage. Based on these considerations, metal silicides represent an attractive class of materials with several desirable features including high electron capacity, high conductivity and high operating voltage (with a theoretical maximum full cell voltage up to about 1.9-2.5 V in some embodiments), high earth abundance and potential environmental benignity that are not readily simultaneously achievable in other competing material systems.

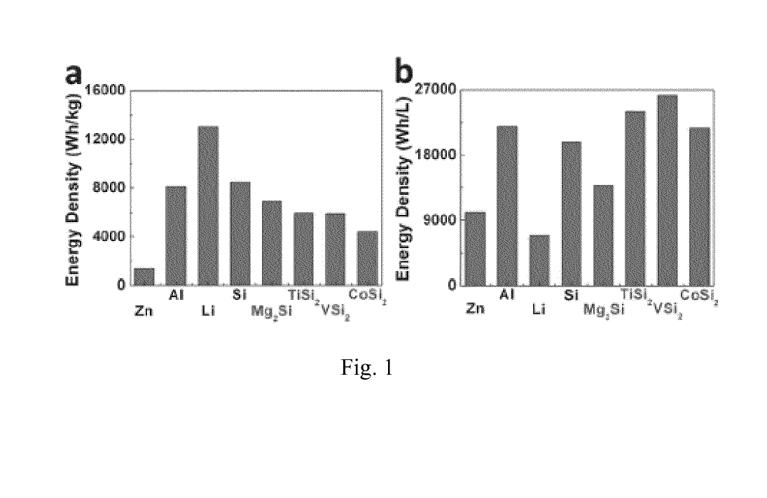

FIG. 1 a shows the theoretical gravimetric energy density of a few representative silicide materials along with Zn, Al, Li, and silicon (Si). To determine the theoretical energy density, the theoretical cell voltage is first calculated based on the thermodynamic properties of the respective materials using the relationship: ΔG=−nfE, where ΔG is the change in the Gibbs free energy, n is the number of electrons, f is the Faraday constant, and E is the cell voltage. The theoretical energy density is then calculated based on complete discharge of the anode material at the theoretical cell voltage. The theoretical volumetric energy density is calculated based on the theoretical gravimetric energy density and the mass density of the anode material.

Silicide materials generally exhibit significantly higher gravimetric energy density than Zn. Beyond the gravimetric energy density, the volumetric energy density is another (and potentially more) important figure-of-merit to consider, particularly important in a system with constrained space. It should be noted that the theoretical volumetric energy density of some silicide materials (e.g., about 26,000 W h L⁻¹ for VSi₂) is about 2-4 times higher than that of Zn (about 10,150 W h L⁻¹) or Li (about 6,890 W h L⁻¹) (FIG. 1b). Additionally, most of the constituent elements of these metal silicides are abundant on earth and environmentally friendly, making them highly attractive for mobile power applications.

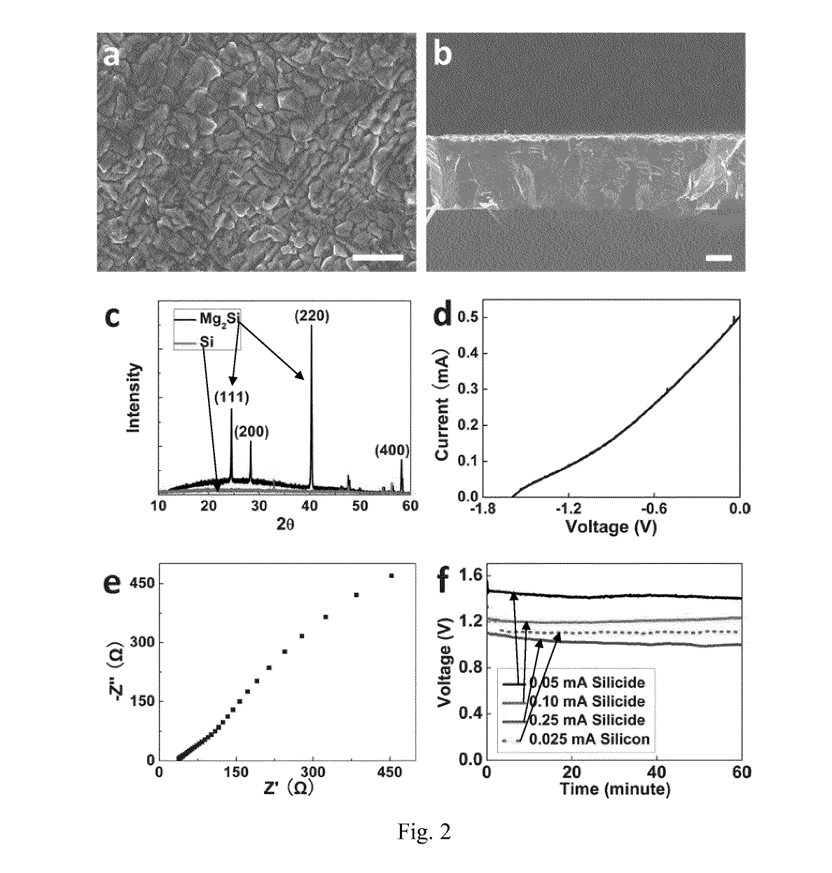

In certain embodiments, silicide films are prepared on a silicon wafer to investigate the performance of the selected silicideair battery system. The magnesium silicide (Mg₂Si) system is used as an initial example system because of its easy preparation, and highest theoretical voltage (up to about 2.5 V) and gravimetric energy density among the silicideair systems considered. The Mg₂Si thin film was obtained by reacting silicon wafer with magnesium vapor in a horizontal tube furnace at about 650° C. for about 60 minutes. FIG. 2a and b show top view and cross-sectional scanning electron microscopy (SEM) images of Mg₂Si grown on a silicon wafer. The as-grown silicide displays a rough surface as a thin film with about 29 μm thickness. X-ray diffraction (XRD) studies demonstrate that the silicide layer can be indexed to the pure cubic structure of Mg₂Si (FIG. 2c).

To further investigate the electrochemical characteristics of the Mg₂Si thin film anode, linear sweep voltammetry and electrochemical impedance spectroscopy (EIS) were performed. The anodic dissolution potential for Mg₂Si is about −1.6 V (FIG. 2d), demonstrating a high open circuit voltage for the Mg₂Siair battery. FIG. 2e shows the impedance study of a Mg₂Si thin film at a potential of 0.2 V. The Nyquist plot in a high frequency region normally reflects the equivalent series resistance (ESR) of the system. The intercept with a real axis is estimated to be about 38 ,Q, indicating a relatively low electrical resistance of the electrode material. The galvanostatic discharge was then carried out with Mg₂Si as an anode (FIG. 20. Consistent with the high anodic dissolution potential, the battery showed a high operating voltage at various discharge currents: about 1.45 V at about 0.05 mA, about 1.21 V at about 0.1 mA, and about 1.01 V at about 0.25 mA. The performance of this thin film silicide battery is more efficient compared to a silicon battery that can be continuously discharged at much lower current (see FIG. 2f for example, the current of the Si air system is about 10 times smaller than that of the Mg₂Siair system at a similar discharge voltage for a similar sized device). Although the operating voltage (about 1.45 V) is still lower than the theoretical number (about 2.5 V), it is significantly higher than that in the siliconair system (about 1.1 V). The relatively low operating voltage compared to the theoretical value can be attributed to the self-discharge and the subsequent polarization of the electrode.

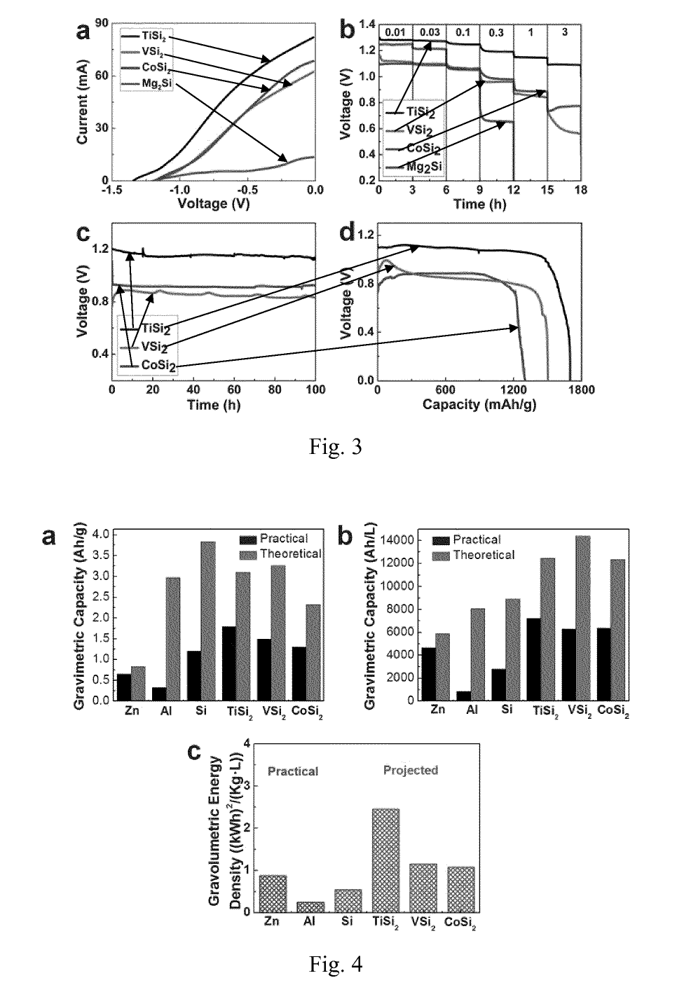

For practical applications, bulk mesh-powders are favored because of their possibility for scalable manufacturing along with other advantages such as low cost and easy assembly. To this end, commercially available silicide powder materials are used to make silicide pellets as an anode. A typical polarization curve for titanium silicide (TiSi₂) in about 30% potassium hydroxide (KOH) solution is shown in FIG. 3a. A potential of about 1.35 V could be expected in the half-cell experiment. A very large current can also be observed (e.g., about 90 mA maximum current for a TiSi₂ pellet in FIG. 3a vs. about 0.5 mA for a Mg₂Si thin film in FIG. 2d), which may be attributed to the high conductivity of the metallic TiSi₂ and a larger surface area in powder format. Unlike many other multi-electron anode materials, no noticeable corrosion (e.g., bubbling) was observed when the TiSi₂ pellet was submerged in the KOH electrolyte, indicating a mild self-discharge characteristic that can deliver a high practical capacity. FIG. 3b shows a discharge measurement with different currents for the TiSi₂ pellet. A voltage of about 1.28 V can be observed at slower discharge rates. Of note, the battery system can maintain a stable voltage as high as about 1.1 V at about 3 mA discharge current and about 1.15 V at about 1 mA (FIG. 3c).

A capacity measurement is also conducted with a full battery including a TiSi₂ anode, an air diffusion cathode, and a gel electrolyte. A full discharge profile (FIG. 3d) using about 1 mA discharge current shows that a flat voltage plateau can be maintained at about 1.1 V, consistent with the results shown in FIG. 3b and c. Evident in the curve, a capacity of about 1,800 mA h g⁻¹ is experimentally achieved, which is close to about 60% of the theoretical capacity based on the anode reaction.

To further investigate the electrochemical behavior of the silicide family, parallel experiments are conducted for VSi₂, CoSi₂, and Mg₂Si pellets, which also provide high theoretical energy densities. With a slightly lower voltage and current, VSi₂ and CoSi₂ show similar behavior in the polarization curve (FIG. 3a). In addition, both VSi₂ and CoSi₂ can sustain a voltage of about 0.85 V and about 0.9 V for extended periods of time at a discharge current of about 1 mA (FIG. 3b and c). The capacity measurements show that VSi₂ and CoSi₂ exhibit an un-optimized practical capacity of about 1500 mA h g⁻¹ and about 1300 mA h g⁻¹, respectively (FIG. 3d). On the other hand, although Mg₂Si of some embodiments has a relatively high voltage, it did not sustain discharge at high current (FIG. 3b), which is consistent with the thin film case (FIG. 2f). Based on these experimental results, TiSi₂ has a higher open circuit voltage, and also offers higher potential at high discharge current among the silicides considered.

This disclosure describes a class of silicideair primary batteries and demonstrates that silicideair batteries can provide a metalair battery system with unparalleled energy density. In some embodiments, TiSi₂ offers a higher anode capacity than other types of anode on both gravimetric and volumetric scales (FIG. 4a and b). For example, the volumetric anode capacity of TiSi₂ can reach about 7,230 A h L⁻¹, which is over 7-fold higher than that of an Alair system (e.g., Altek Fuel Group Inc. model APS 100-12, capacity 120 A h L⁻¹, Al anode 0.37 kg). The areal energy density can also be determined by normalizing the overall energy by the surface area of the active anode electrode (about 0.5 cm²). For example, for the TiSi₂ anode at a discharge current of about 1 mA (FIG. 3d), the reaction area is about 0.5 cm² and the anode weight consumption is about 80 mg. Assuming that the active anode material amounts to about 40% of the total device, the energy density per area can be calculated by 40%×1.1 V×1.8 (A h g⁻¹)×0.08 g/0.5 cm²=0.127 W h cm⁻².

For many practical applications with limited space or mass loading capacity, both gravimetric and volumetric energy densities are important metrics to consider. To properly evaluate both scales with a single unit, it is proposed to use the product of gravimetric and volumetric energy density to specify a figure-of-merit for energy density gravolumetric energy density. The reciprocal of this number also carries an important physical meaning the product of mass and volume of the material to generate a unit of energy (e.g., W h). It therefore specifies a parameter that characterizes the mass and volume of a chosen material to provide a given amount of energy. A well-developed metalair system typically has an active anode material weight ratio of about 40% of the total battery weight. Therefore, the gravolumetric energy density of the silicide system is projected based on this ratio, and compared with the practical gravolumetric energy density of Znair and Al air systems (Altek Fuel Group Inc. model APS 100-12, specific energy of about 300 W h kg⁻¹). With this figure-of-merit, the silicide system offers significant combined advantages over other metalair technologies, with the practical gravolumetric energy density of the TiSi₂air system more than about 3-10 times better than that of Znair or Alair technologies (FIG. 4c).

The silicide anode materials described herein can be used for a variety of batteries and other electrochemical energy storage devices. For example, the silicide anode materials can be substituted in place of, or used in conjunction with, conventional anode materials for metal-air batteries.

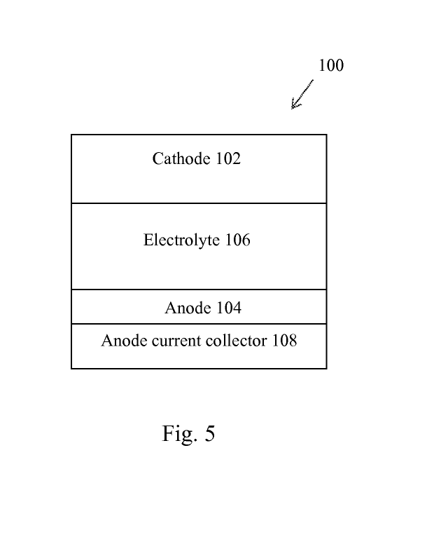

FIG. 5 shows a schematic of a silicideair battery 100 that includes a cathode 102, an anode 104, and an electrolyte 106 that is disposed between the cathode 102 and the anode 104. The anode 104 includes, or is formed of, a silicide anode material as described herein where oxidation occurs, and the cathode 102 can be any suitable cathode where reduction of oxygen occurs, such as an air diffusion electrode or an electrode including, or formed of, a carbon-based material and optionally a set of oxygen reduction catalysts. As shown in FIG. 5, the silicideair battery 100 also includes an anode current collector 108 (e.g., a metal foil or a silicon wafer), and the anode 104 can be formed integrally with the anode current collector 108 or can be connected to the anode current collector 108. Together, the anode 104 and the anode current collector 108 can correspond to an anode structure for the silicideair battery 100. It is also contemplated that the anode current collector 108 can be omitted in some embodiments.

The silicide anode material includes a metal silicide, and, in some embodiments, can be represented as: MₓSi_{y}, where M is at least one metal selected from, for example, alkali metals (or metals of Group 1, including lithium, sodium, potassium, rubidium, and cesium), alkaline earth metals (or metals of Group 2, including beryllium, magnesium, calcium, strontium, and barium), transition metals (or metals of Groups 3, 4, 5, 6, 7, 8, 9, 10, 11, and 12), and post-transition metals (or aluminum, gallium, indium, tin, thallium, lead, bismuth, and polonium). In some embodiments, M is an alkaline earth metal, such as magnesium, and, in other embodiments, M is a transition metal, such as titanium (or another metal of Group 4), cobalt (or another metal of Group 9), or vanadium (or another metal of Group 5). In some embodiments, M is a transition metal of Period 4 of the period table, namely scandium, titanium, vanadium, chromium, manganese, iron, cobalt, nickel, copper, and zinc. In some embodiments, M is a transition metal of Period 5 of the period table, namely yttrium, zirconium, niobium, molybdenum, technetium, ruthenium, rhodium, palladium, silver, and cadmium. In some embodiments, x is in the range of about 1 to about 20, such an integer or non-integer in the range of about 1 to about 20, in the range of about 1 to about 15, in the range of about 1 to about 10, in the range of about 1 to about 5, in the range of about 1 to about 4, in the range of about 1 to about 3, or in the range of about 1 to about 2, and y is in the range of about 1 to about 20, such an integer or non-integer in the range of about 1 to about 20, in the range of about 1 to about 15, in the range of about 1 to about 10, in the range of about 1 to about 5, in the range of about 1 to about 4, in the range of about 1 to about 3, or in the range of about 1 to about 2. In some embodiments, x is about 1 or about 2, and y is about 1 or about 2. In some embodiments, x is about 1, and y is about 2. In other embodiments, x is about 2, and y is about 1. In some embodiments, a ratio of x and y (or x/y) is at least or greater than about 1, such as at least or greater than about 1.5 or at least or greater than about 2. In other embodiments, a ratio of x and y (or x/y) is less than about 1. In some embodiments, the silicide anode material can be represented as, for example, (M1)ₓ₁(M2)ₓ₂Si_{y} or (M1)ₓ₁(M2)ₓ₂(M3)ₓ₃Si_{y}, where M1 and M2 (or M1, M2, and M3) are different metals selected from the above-listed examples, and a sum of x1 and x2 (or a sum of x1, x2, and x3) corresponds to x as explained above. The silicide anode material can be provided as, for example, a thin film, a powder form, or a pellet form.

In some embodiments, the silicide-air battery 100 of FIG. 5 has an operating voltage of at least about 0.8 V, when discharged at a rate of about 1 mA (or about 0.01 mA, about 0.03 mA, about 0.3 mA, about 0.1 mA, about 3 mA, or another higher or lower discharge rate), such as at least about 0.85 V, at least about 0.9 V, at least about 0.95 V, at least about 1 V, at least about 1.05 V, at least about 1.1 V, at least about 1.15 V, or at least about 1.2 V, and up to about 1.9 V, or more. In some embodiments, the silicideair battery 100 of FIG. 5 has a capacity of at least about 1,200 mAh g⁻¹, when discharged at a rate of about 1 mA (or about 0.01 mA, about 0.03 mA, about 0.3 mA, about 0.1 mA, about 3 mA, or another higher or lower discharge rate), such as at least about 1,250 mAh g⁻¹, at least about 1,300 mAh g⁻¹, at least about 1,350 mAh g⁻¹, at least about 1,400 mAh g⁻¹, at least about 1,450 mAh g⁻¹, at least about 1,500 mAh g⁻¹, at least about 1,550 mAh g⁻¹, at least about 1,600 mAh g⁻¹, at least about 1,650 mAh g⁻¹, at least about 1,700 mAh g⁻¹, at least about 1,750 mAh g⁻¹, or at least about 1,800 mAh g⁻¹, and up to about 2,000 mAh g⁻¹ or more.

This disclosure describes a class of silicideair batteries and demonstrates the use of silicide materials as anodes in a primary metalair battery system with unparalleled anode capacity. Several features of silicide materials, including high electron capacity, high conductivity, high operating voltage, high earth abundance, and potential environmental benignity, make them an excellent class of materials for ultra-high density energy storage. With the high conductivity of metal silicides, conductive materials such as carbon black can be omitted in the system (or otherwise can comprise no greater than about 10% by weight of an anode, such as no greater than about 5% by weight, no greater than about 4% by weight, no greater than about 3% by weight, no greater than about 2% by weight, or no greater than about 1% by weight), which ensures high energy density in practical usage. Additionally, many of these silicide materials are generally composed of earth abundant and environmentally friendly elements to provide sustainable lower cost manufacturing. For example, comparing earth abundance of constituting elements of TiSi₂ with the current (Zn) or emerging (Al, Li) air battery anode materials, Si (about 270,000 ppm) is more than 3 times more abundant than Al (about 82,000 ppm) and about 3-4 orders of magnitude more abundant than Zn (about 79 ppm) and Li (about 17 ppm), and Ti (about 6,600 ppm) is about 2-3 orders of magnitude more abundant than Zn and Li. With the implementation of tri-electrode cell configuration and highly efficient oxygen reduction/evolution reaction catalysts, secondary silicideair systems can also be implemented with superior anode capacity and high practical energy density. With optimization and process development, silicide materials can provide a class of batteries with ultra-high energy density, thereby opening up opportunities for mobile power and other applications.

### EXAMPLE

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

Experimental Section

Magnesium silicide thin film fabrication and measurement: Magnesium silicide thin films were synthesized in a horizontal tube furnace (Lindberg/Blue M, Thermo Scientific) with a 1-inch diameter quartz tube. An n-type silicon wafer with resistivity of about 0.001-0.002 Q.cm (University Wafers) was placed on the top of an alumina boat filled with magnesium powder (about 99.8%, Alfa Aeser). The alumina boat was then placed in the center of the furnace. Finally, the chamber was heated to about 650° C. under argon flow for about 1 hour followed by natural cooling to room temperature to obtain a silicon substrate with a layer of blue silicide thin film (about 30 μm thick).

Magnesium silicide thin film electrochemical performance measurement: The battery device including a silicide thin film with a film thickness of about 30 μm on the silicon wafer (about 1.5 cm×about 2 cm, about 500 μm thick), an air diffusion electrode (Quantumsphere Co. Ltd), and a polydimethylsiloxane (PDMS) stamp with an open-through hole (about 0.5 cm diameter) was sandwiched tightly by aluminum sheet and plastic plate with open windows at the center of the air electrode to allow air diffusion. An aqueous solution of about 30% potassium hydroxide (KOH) was then injected into the cell as the electrolyte.

Silicide pellet electrochemical performance measurement: About 1.5 g of TiSi₂ (about 99.5%), CoSi₂ (about 99%), and VSi₂ (about 99.5%) and about 0.7 g of Mg₂Si (about 99.5%) powders (Alfa Aeser) were pressed to form pellets with about 0.5 inch in diameter and about 0.25 cm in height and annealed under argon flow for about 2 hours at different temperatures (about 1,100° C. for TiSi₂ and VSi₂, about 900° C. for CoSi₂, about 700° C. for Mg₂Si). Discharge measurements were then carried out with the silicide pellet as anode, an air diffusion electrode as cathode, and about 30% potassium hydroxide (KOH) as the electrolyte.

Silicide powder capacity measurement: For the capacity measurement, a gel was made by adding poly-acrylic acid (Carbopol 711, BF Goodrich) into KOH solution. The gel was then casted onto a metal (nickel) foil (about 0.025 mm thick, Alfa Aesar) with silicide powder. A full cell is constructed similarly except that the silicon wafer was substituted with the silicide pasted nickel foil with a separator (Celgard 3501) on the top.

Characterization: Discharge curves were achieved using a Maccor 4304 battery test system. Linear sweep voltammograms and electrochemical impedance spectroscopy were performed with a 3-electrode configuration on VersaSTAT 4 from Princeton Applied Research. The as-synthesized magnesium silicide thin films were characterized by scanning electron microscopy (SEM JEOL 6700) and Energy-dispersive X-ray spectroscopy. X-ray diffraction (XRD) pattern was carried out by a Bruker Smart 1000K Single Crystal X-ray Diffractometer.

Calculation of Theoretical Voltages for Various Metal Silicides

Magnesium Silicide

At the Anode: Mg₂Si+8OH⁻→2MgO+SiO₂+4H₂O+8e⁻¹ (E⁰=2.09 V)

At the Cathode: O₂+2H₂O+4e⁻→4OH⁻ (E⁰=0.40 V)

Overall Reaction: Mg₂Si+2O₂→2MgO+SiO₂ (E⁰_{cell}=2.49 V)

Thermodynamic reaction to obtain anode half-cell:

Mg₂Si+8OH⁻→2MgO+SiO₂+4H₂O (E⁰=2.09 V)

ΔG′_{f}(H₂O, l)=−237.1 kjmol⁻¹

ΔG′_{f}(SiO₂, s)=−056.3 kjmol⁻¹

ΔG′_{f}(Mg₂Si, s)=−75.31 kjmol⁻¹

ΔG′_{f}(OH⁻, ag)=−157.2 kjmol⁻¹

ΔG′_{f}(MgO, s)=−569.3 kjmol⁻¹

$$\begin{matrix}Δ {G}_{R}^{°} = 2 Δ {G}_{f}^{°} ( MgOs ) + Δ {G}_{f}^{°} ( {SiO}_{2} , s ) + 4 Δ {G}_{f}^{°} ( {H}_{2} O , l ) - \\ Δ {G}_{f}^{°} ( {Mg}_{2} Si , s ) - 8 Δ {G}_{f}^{°} ( {OH}^{-} , aq ) \\ = 2 \times - 569.3 kJ {mol}^{- 1} - 1 \times 856.3 kJ {mol}^{- 1} - 4 \times \\ 237.1 kJ {mol}^{- 1} + 75.31 kJ {mol}^{- 1} + \\ 8 \times 157.2 kJ {mol}^{- 1}\end{matrix}$$

$$Δ {G}_{R}^{°} = - 1610.4 kJ {mol}^{- 1}$$

$$Δ {G}_{R}^{°} = - {nfE}^{0} \\ - 1610.4 = - 8 \times 96.485 \times {E}^{0}$$

$${E}^{0} = 2.0 \% V$$

Titanium Silicide

At the Anode: TiSi₂+12OH⁻→TiO₂+2SiO₂+6H₂O+12e⁻ (E⁰=1.53 V)

At the Cathode: O₂+2H₂O+4e⁻→4OH⁻ (E⁰=0.40 V)

Overall Reaction: TiSi₂+3O₂→TiO₂+2SiO₂ (E⁰_{cell}=1.93 V)

Thermodynamic reaction to obtain anode half-cell:

TiSi₂+12OH⁻→TiO₂+2SiO₂+6H₂O+12e⁻ (E⁰=1.53 V)

ΔG′_{f}(H₂O, l)=−237.1 kjmol⁻¹

ΔG′_{f}(SiO₂, s)=−856.3 kjmol⁻¹

ΔG′_{f}(TiC₂, s)=−888.8 kjmol⁻¹

ΔG′_{f}(OH⁻, aq)=−157.2 kjmol⁻¹

ΔG′_{f}(TiSi₂, s)=−127.0 kjmol⁻¹

$$\begin{matrix}Δ {G}_{R}^{°} = Δ {G}_{f}^{°} ( {TiO}_{2} , s ) + 2 Δ {G}_{f}^{°} ( {SiO}_{2} , s ) + 6 Δ {G}_{f}^{°} ( {H}_{2} O , l ) - \\ Δ {G}_{f}^{°} ( {TiSi}_{2} , s ) - 12 Δ {G}_{f}^{°} ( {OH}^{-} , aq ) \\ = - 888.8 kJ {mol}^{- 1} - 2 \times 856.3 kJ {mol}^{- 1} - 5 \times \\ 237.1 kJ {mol}^{- 1} + 127.0 kJ {mol}^{- 1} + \\ 12 \times 157.2 kJ {mol}^{- 1}\end{matrix}$$

$$Δ {G}_{R}^{°} = - 1773.3 kJ {mol}^{- 1}$$

$$Δ {G}_{R}^{°} = - {nfE}^{0} \\ - 1768.3 = - 12 \times 96.485 \times {E}^{0}$$

$${E}^{0} = 1.527 V$$

Vanadium Silicide

At the Anode: VSi₂+13OH⁻→½ V₂O₅+2SiO₂+13/2H₂O+13e⁻(E⁰=1.42 V)

At the Cathode: O₂+2H₂O 30 4e⁻→4OH⁻ (E⁰=0.40 V)

Overall Reaction: VSi₂+13/2O₂→½V₂O₅+2SiO₂ (E⁰_{cell}=1.82 V)

Thermodynamic reaction to obtain anode half-cell:

VSi₂+13OH⁻→½V₂O₅+2SiO₂+13/2H₂O+13e⁻ (E⁰=1.42 V)

ΔG′_{f}(H₂O, l)=−237.1 kjmol⁻¹

ΔG′_{f}(SiO₂, s)=−856.3 kjmol⁻¹

Δg′_{f}(VSl₂, s)==39.37 kjmol⁻¹

ΔG′_{f}(OH⁻, aq)=−157.2 kjmol⁻¹

ΔG′_{f}(V₂O_{g},s)=−1205.9 kjmol⁻¹

$$\begin{matrix}Δ {G}_{R}^{°} = Δ {G}_{f}^{°} ( {V}_{2} {O}_{5} , s ) + 2 Δ {G}_{f}^{°} ( {SiO}_{2} , s ) + 5 Δ {G}_{f}^{°} ( {H}_{2} O , l ) - \\ Δ {G}_{f}^{°} ( {CoSi}_{2} , s ) - 10 Δ {G}_{f}^{°} ( {OH}^{-} , aq ) \\ = \frac{1}{2} \times - 1205.9 kJ {mol}^{- 1} - 2 \times 856.3 kJ {mol}^{- 1} - \frac{13}{2} \times \\ 237.1 kJ {mol}^{- 1} + 39.37 kJ {mol}^{- 1} + \\ 13 \times 157.2 kJ {mol}^{- 1}\end{matrix}$$

$$Δ {G}_{R}^{°} = - 1776.8 kJ {mol}^{- 1}$$

$$Δ {G}_{R}^{°} = - {nfE}^{0} \\ - 1776.8 = - 13 \times 96.485 \times {E}^{0}$$

$${E}^{0} = 1.4166 V$$

Cobalt Silicide

At the Anode: CoSi₂+100H⁻→CoO+2SiO₂+5H₂O+10e⁻ (E⁰=1.50 V)

At the Cathode: O₂+2H₂O+4e⁻→4OH⁻ (E⁰ =0.40 V)

Overall Reaction: CoSi₂+5O₂→CoO+2SiO₂ (E⁰_{cell}=1.90 V)

Thermodynamic reaction to obtain anode half-cell:

CoSi₂+100H⁻→CoO+2SiO₂+5H₂O+10e⁻ (E⁰=1.50 V)

ΔG′_{f}(H₂O, l)=−287.1 kjmol⁻¹

ΔG′_{f}(SiO₂, s)=−856.3 kjmol⁻¹

ΔG′_{f}(CoO, s)=−214.2 kjmol⁻¹

ΔG′_{f}(OH⁻, ag)=−157.2 kjmol⁻¹

ΔG′_{f}(Cost₂, s)=−97.6 kjmol⁻¹

$$\begin{matrix}Δ {G}_{R}^{°} = Δ {G}_{f}^{°} ( CoO , s ) + 2 Δ {G}_{f}^{°} ( {SiO}_{2} , s ) + 5 Δ {G}_{f}^{°} ( {H}_{2} O , l ) - \\ Δ {G}_{f}^{°} ( {CoSi}_{2} , s ) - 10 Δ {G}_{f}^{°} ( {OH}^{-} , aq ) \\ = - 214.2 kJ {mol}^{- 1} - 2 \times 856.3 kJ {mol}^{- 1} - 5 \times \\ 237.1 kJ {mol}^{- 1} + 97.6 kJ {mol}^{- 1} + \\ 10 \times 157.2 kJ {mol}^{- 1}\end{matrix}$$

$$Δ {G}_{R}^{°} = - 1442.7 kJ {mol}^{- 1}$$

$$Δ {G}_{R}^{°} = - {nfE}^{0} \\ - 1442.7 = - 10 \times 96.485 \times {E}^{0}$$

$${E}^{0} = 1.495 V$$

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, the terms can refer to less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the terms “connect,” “connected,” and “connection” refer to an operational coupling or linking Connected objects can be directly coupled to one another or can be indirectly coupled to one another, such as via another set of objects.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A silicide-air battery comprising:
an anode;
a cathode; and
an electrolyte disposed between the anode and the cathode,
wherein the anode includes a metal silicide represented as MₓSi_{y}, where M is at least one metal selected from alkaline earth metals, transition metals, and post-transition metals.

2. The silicide-air battery of claim 1, wherein M is an alkaline earth metal.

3. The silicide-air battery of claim 2, wherein M is Mg.

4. The silicide-air battery of claim 1, wherein M is a transition metal.

5. The silicide-air battery of claim 4, wherein M is selected from Ti, Co, and V.

6. The silicide-air battery of claim 1, wherein x is in the range of 1 to 20, and y is in the range of 1 to 20.

7. The silicide-air battery of claim 1, wherein x is in the range of 1 to 5, and y is in the range of 1 to 5.

8. The silicide-air battery of claim 1, wherein x is 1 or 2, and y is 1 or 2.

9. The silicide-air battery of claim 1, wherein x is 2, and y is 1.

10. The silicide-air battery of claim 1, wherein the metal silicide is selected from Mg₂Si, TiSi₂, CoSi₂, and VSi₂.

11. The silicide-air battery of claim 1, wherein the cathode is an air diffusion electrode.

12. An anode structure comprising:
a current collector; and
an anode connected to the current collector,
wherein the anode includes a silicide including at least one metal selected from alkaline earth metals, transition metals, and post-transition metals.

13. The anode structure of claim 12, wherein the silicide is represented as MₓSi_{y}, where M is an alkaline earth metal, x is in the range of 1 to 20, and y is in the range of 1 to 20.

14. The anode structure of claim 13, wherein M is Mg.

15. The anode structure of claim 12, wherein the silicide is represented as MₓSi_{y}, where M is a transition metal, x is in the range of 1 to 20, and y is in the range of 1 to 20.

16. The anode structure of claim 15, wherein M is selected from transition metals of Period 4 of the periodic table.

17. The anode structure of claim 15, wherein M is selected from Ti, Co, and V.

18. The anode structure of claim 12, wherein the silicide is represented as (M1)ₓ₁(M2)ₓ₂Si_{y}, where M1 and M2 are different metals selected from alkaline earth metals, transition metals, and post-transition metals, a sum of x1 and x2 is in the range of 1 to 20, and y is in the range of 1 to 20.
